(19) United States
(12) Patent Application Publication
(10) Pub. No.: US 2026/0100794 A1
(43) Pub. Date: Apr. 9, 2026

(54) REPORTING A TIME-DOMAIN CHANNEL PROPERTY REPORT

(71) Applicant: Lenovo (Singapore) Pte. Ltd., Singapore (SG)

(72) Inventors: Ahmed Hindy, Aurora, IL (US); Vijay Nangia, Woodridge, IL (US)

(21) Appl. No.: 19/111,933

(22) PCT Filed: Sep. 25, 2023
(86) PCT No.: PCT/IB2023/059453

§ 371 Date: Mar. 14, 2025

Related U.S. Application Data
(60) Provisional application No. 63/376,821, filed on Sep. 23, 2022.

(51) Int. Cl. H04L 5/00; H04W 72/0446

(52) U.S. Cl. CPC H04L 5/0051; H04W 72/0446

(57) ABSTRACT

Apparatuses, methods, and systems are disclosed for reporting a time-domain channel property (“TDCP”) report. One method (800) includes receiving (802), at a device, a TDCP reporting setting including configuration parameters corresponding to a TDCP report. The TDCP reporting setting is associated with at least one tracking reference signal (“TRS”) received at the device. The method (800) includes reporting (804) the TDCP report over a physical uplink channel. The TDCP report includes a set of parameters based on a measure of a downlink channel correlation over time.

### FIELD

The subject matter disclosed herein relates generally to wireless communications and more particularly relates to reporting a time-domain channel property (“TDCP”) report.

### BACKGROUND

In certain wireless communications systems, channel state information (“CSI”) feedback may be reported. In such systems, the CSI feedback may vary in size, time, and frequency granularity.

### BRIEF SUMMARY

Methods for reporting a TDCP report are disclosed. Apparatuses and systems also perform the functions of the methods. One embodiment of a method includes receiving, at a device, a TDCP reporting setting including configuration parameters corresponding to a TDCP report. The TDCP reporting setting is associated with at least one tracking reference signal (“TRS”) received at the device. In some embodiments, the method includes reporting the TDCP report over a physical uplink channel. The TDCP report includes a set of parameters based on a measure of a downlink channel correlation over time.

One apparatus for reporting a TDCP report includes a processor. In some embodiments, the apparatus includes a memory coupled with the processor, the processor configured to cause the apparatus to: receive a TDCP reporting setting including configuration parameters corresponding to a TDCP report, wherein the TDCP reporting setting is associated with at least one TRS received at the apparatus; and receive the TDCP report over a physical uplink channel, wherein the TDCP report includes a set of parameters based on a measure of a downlink channel correlation over time.

Another embodiment of a method for reporting a TDCP report includes transmitting, at a device, a TDCP reporting setting including configuration parameters corresponding to a TDCP report. The TDCP reporting setting is associated with at least one TRS transmitted from the device. In some embodiments, the method includes receiving the TDCP report over a physical uplink channel. The TDCP report includes a set of parameters based on a measure of a downlink channel correlation over time.

Another apparatus for reporting a TDCP report includes a processor. In some embodiments, the apparatus includes a memory coupled to the processor, the processor configured to cause the apparatus to: transmit a TDCP reporting setting including configuration parameters corresponding to a TDCP report, wherein the TDCP reporting setting is associated with at least one TRS transmitted from the apparatus; and receive the TDCP report over a physical uplink channel, wherein the TDCP report includes a set of parameters based on a measure of a downlink channel correlation over time.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reporting a TDCP report;

FIG. 2 is a schematic block diagram illustrating one embodiment of an apparatus that may be used for reporting a TDCP report:

FIG. 3 is a schematic block diagram illustrating one embodiment of an apparatus that may be used for reporting a TDCP report:

FIG. 4 is a schematic block diagram illustrating one embodiment of code for an aperiodic trigger state that indicates a resource set and QCL information:

FIG. 5 is a schematic block diagram illustrating one embodiment of code that describes a radio resource control (“RRC”) configuration for an NZP-CSI-RS resource:

FIG. 6 is a schematic block diagram illustrating one embodiment of code that describes an RRC configuration for a CSI-IM resource:

FIG. 7 is a schematic block diagram illustrating one embodiment of code for a TRS resource set configuration:

FIG. 8 is a flow chart diagram illustrating one embodiment of a method for reporting a TDCP report; and

FIG. 9 is a flow chart diagram illustrating another embodiment of a method for reporting a TDCP report.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the FIGS. illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

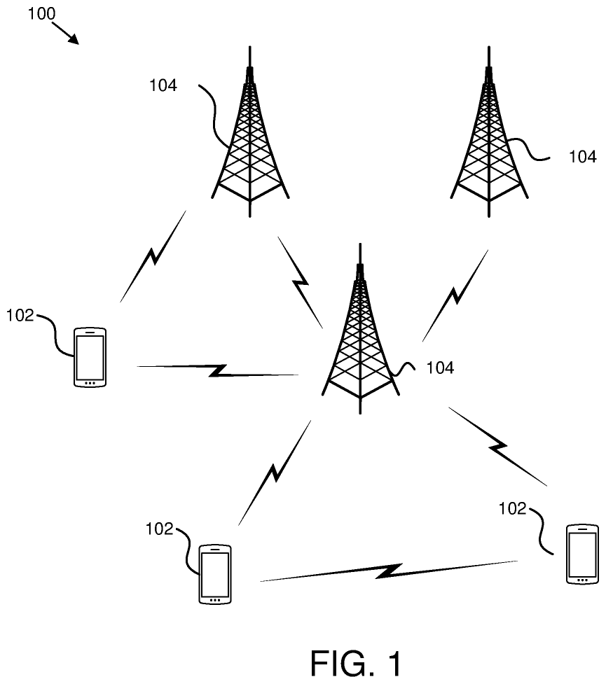

FIG. 1 depicts an embodiment of a wireless communication system 100 for reporting a TDCP report. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R′, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a TDCP reporting setting including configuration parameters corresponding to a TDCP report. The TDCP reporting setting is associated with at least one TRS received at the device. In some embodiments, the remote unit 102 may report the TDCP report over a physical uplink channel. The TDCP report includes a set of parameters based on a measure of a downlink channel correlation over time. Accordingly, the remote unit 102 may be used for reporting a TDCP report.

In certain embodiments, a network unit 104 may transmit a TDCP reporting setting including configuration parameters corresponding to a TDCP report. The TDCP reporting setting is associated with at least one TRS transmitted from the device. In some embodiments, the network unit 104 may receive the TDCP report over a physical uplink channel. The TDCP report includes a set of parameters based on a measure of a downlink channel correlation over time. Accordingly, the network unit 104 may be used for reporting a TDCP report.

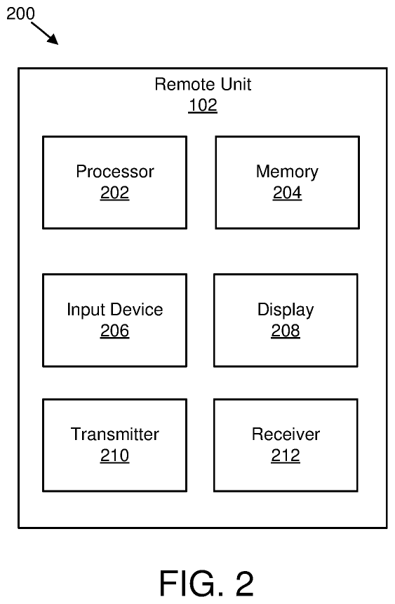

FIG. 2 depicts one embodiment of an apparatus 200 that may be used for reporting a TDCP report. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the apparatus to: receive a TDCP reporting setting including configuration parameters corresponding to a TDCP report, wherein the TDCP reporting setting is associated with at least one TRS received at the apparatus; and receive the TDCP report over a physical uplink channel, wherein the TDCP report includes a set of parameters based on a measure of a downlink channel correlation over time.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

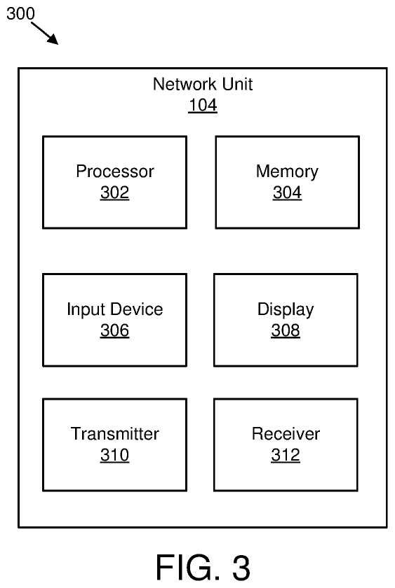

FIG. 3 depicts one embodiment of an apparatus 300 that may be used for reporting a TDCP report. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the apparatus to: transmit a TDCP reporting setting including configuration parameters corresponding to a TDCP report, wherein the TDCP reporting setting is associated with at least one TRS transmitted from the apparatus; and receive the TDCP report over a physical uplink channel, wherein the TDCP report includes a set of parameters based on a measure of a downlink channel correlation over time.

It should be noted that one or more embodiments described herein may be combined into a single embodiment.

In certain embodiments, such as for 3GPP NR, CSI feedback is reported by a UE to a network, where the CSI feedback may take multiple forms based on a CSI feedback report size, time, and frequency granularity. In NR, high-resolution CSI feedback report (e.g., Type-II) was specified, where the frequency granularity of the CSI feedback may be indirectly parametrized. In addition, scenarios in which the UE speed is relatively high (e.g., up to 500 km/h) may occur. To accommodate such scenarios while maintaining similar quality of service, a modified CSI framework, including measurement and reporting, may be used, wherein some CSI parameters corresponding to Doppler-domain or a temporal correlation of the channel, are fed back (e.g., in a standalone report).

In some embodiments, a UE may be configured with periodic CSI reference signal (“RS”) (“CSI-RS”) measurement and CSI reporting with a small periodicity value. In such embodiments, there may be significant CSI-RS overhead and CSI feedback overhead.

In various embodiments, a UE may be configured with reporting a channel correlation across time as well as Doppler shift and/or Doppler spread information may be configured to enable a network to update its configuration based on a temporal channel correlation. In such embodiments, channel correlation values may not provide sufficient indications on which CSI report quantities need to be updated (e.g., whether configuration parameters corresponding to precoding, channel quality, or a combination thereof need to be changed).

In certain embodiments, a UE may be configured with reporting a TDCP report that indicates a three-level prediction of the channel correlation across time including: 1) a strong temporal channel correlation, under which the channel is expected to maintain most of its properties (and hence reuse the same CSI configuration) for a given period of time (in terms of a number of slots); 2) a moderate temporal channel correlation, under which the channel is expected to maintain some of its basic properties (and hence partially reuse the same CSI configuration) for a given period of time; and 3) a low temporal channel correlation, under which the channel is expected to revert from most of its basic properties (and hence fully update the CSI configuration) for a given period of time.

In some embodiments, a UE may be configured with reporting two TRSs: a first TRS corresponding to legacy use cases, and a second TRS corresponding to TDCP reporting, wherein the UE feeds back information corresponding to the temporal channel correlation strength based on at least the second TRS.

In certain embodiments, there may be different NR codebook types. Details about different NR codebook types are provided herein.

In some embodiments, there is an NR Type-II codebook. In such embodiments, assume the gNB is equipped with a 2D antenna array with N₁, N₂ antenna ports per polarization placed horizontally and vertically and communication occurs over N₃ precoder matrix indicator (“PMI”) sub-bands. A PMI subband consists of a set of resource blocks, each resource block consisting of a set of subcarriers. In such case, 2N₁N₂ CSI-RS ports are utilized to enable DL channel estimation with high resolution for NR Type-II codebook. In order to reduce the UL feedback overhead, a discrete Fourier transform (“DFT”)-based CSI compression of the spatial domain is applied to L dimensions per polarization, where L<N₁N₂. In the sequel the indices of the 2L dimensions are referred as the SD basis indices. The magnitude and phase values of the linear combination coefficients for each sub-band are fed back to the gNB as part of the CSI report. The 2N₁N₂×N₃ codebook per layer takes on the form: W=W₁W₂, where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = [ \begin{matrix}{u}_{m} & {e}^{j \frac{2 π l}{{O}_{1} {N}_{1}}} {u}_{m} & … & {e}^{{j \frac{2 π l ( {N}_{1} - 1 )}{{O}_{1} {N}_{1}} ]}^{T}} {u}_{m} ]\end{matrix} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ]\end{matrix} ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on O₁ and O₂ values. Note that W₂ are independent for different layers.

In various embodiments, there may be an NR Type-II port selection codebook. In such embodiments, for Type-II port selection codebook, only K (where K≤2N₁N₂) beamformed CSI-RS ports are utilized in DL transmission, in order to reduce complexity. The K×N₃ codebook matrix per layer takes on the form:

$$W = {W}_{1}^{PS} {W}_{2} .$$

Here, W₂ follow the same structure as the conventional NR Rel. 15 Type-II Codebook and are layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{Ps} {d}_{PS} , K / 2}^{( K / 2 )} & {e}_{mod ( {m}_{Ps} {d}_{PS} , K / 2}^{( K / 2 )} & … & {e}_{mod ( {m}_{Ps} {d}_{PS} + L - 1 , K / 2 )}^{( K / 2 )} ]\end{matrix} ,$$

where

$${e}_{i}^{( K )}$$

is a standard unit vector with a 1 at the i^{th} location. Here d_{PS} is a RRC parameter which takes on the values {1, 2, 3, 4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers. For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0, 1, 2, 3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0, 1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In various embodiments, there may be an NR Type-I codebook. In such embodiments, NR Type-I codebook is the baseline codebook for NR, with a variety of configurations. The most common utility of Type-I codebook is a special case of NR Type-II codebook with L=1 for RI=1, 2, wherein a phase coupling value is reported for each sub-band, i.e., W₂ is 2×N₃, with the first row equal to [1, 1, . . . , 1] and the second row equal to [e^{j2πØ}^{₀}, . . . , e^{j2πØN}^{₃₋₁}]. Under specific configurations, φ₀=φ₁ . . . =φ, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

In certain embodiments, there may be an NR Type-II codebook. In such embodiments, assume the gNB is equipped with a two-dimensional (2D) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$$W = {W}_{1} {\tilde{W}}_{2} {W}_{f}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1.$$

Note that O₁, O₂ oversampling factors are assumed for the 2D DFT matrix from which matrix B is drawn. Note that W₁ is common across all layers. W_{f} is an N₃×M matrix (M<N₃) with columns selected from a critically sampled size-N₃ DFT matrix, as follows:

$${W}_{f} = [ \begin{matrix}{f}_{{k}_{0}} & {f}_{{k}_{1}} & ⋯ & {f}_{{k}_{{M}^{′} - 1}}\end{matrix} ] , 0 \leq {k}_{i} < {N}_{3} - 1 ,$$

$${f}_{k} = {[ \begin{matrix}1 & {e}^{- j \frac{2 π m}{{N}_{3}}} & ⋯ & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁ and O₂ values. Similarly, for W_{f}, only the indices of the M selected columns out of the predefined size-N₃ DFT matrix are reported. In the sequel the indices of the M dimensions are referred as the selected frequency domain (“FD”) basis indices. Hence, L, M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}₂, W_{f} are selected independent for different layers. Magnitude and phase values of an approximately β fraction of the 2 LM available coefficients are reported to the gNB (β1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients' information.

In some embodiments, there may be an NR Type-II port selection codebook. For Type-II port selection codebook, only K (where K≤2N₁N₂) beamformed CSI-RS ports are utilized in DL transmission, in order to reduce complexity. The K×N₃ codebook matrix per layer takes on the form:

$$W = {W}_{1}^{PS} {\tilde{W}}_{2 , l} {W}_{f , l}^{H} .$$

Here, \tilde{W}_{2,l} and W_{3,l} follow the same structure as the conventional NR Type-II Codebook, where both are layer specific. The matrix W₁^{PS} is a K×2L block-diagonal matrix with the same structure as that in the NR Type-II port selection codebook.

In some embodiments, there may be another NR Type-II port selection codebook. For this Type-II port selection codebook, it may take on the form:

$$W = {W}_{1}^{PS} {\tilde{W}}_{2 , l} {W}_{f , l}^{H} .$$

The port-selection matrix W̅₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,1} and W_{f,l} follow the same structure as the conventional NR Type-II Codebook, however M is limited to 1,2 only, with the network configuring a window of size N={2,4} for M=2. Moreover, the bitmap is reported unless β=1 and the UE reports all the coefficients for a rank up to a value.

In various embodiments, there may be codebook reporting. The codebook report is partitioned into two parts based on the priority of information reported. Each part is encoded separately (Part 1 has a possibly higher code rate).

In certain embodiments, there may be a content of a CSI report as follows. Part 1: rank indicator (“RI”)+CQI+Total number of coefficients. Part 2: SD basis indicator+FD basis indicator/layer+Bitmap/layer+Coefficient Amplitude info/layer+Coefficient Phase info/layer+Strongest coefficient indicator/layer. Furthermore, Part 2 CSI can be decomposed into sub-parts each with different priority (higher priority information listed first). Such partitioning is required to allow dynamic reporting size for codebook based on available resources in the uplink phase. Also Type-II codebook is based on aperiodic CSI reporting, and only reported in physical uplink shared channel (“PUSCH”) via downlink control information (“DCI”) triggering (one exception). Type-I codebook can be based on periodic CSI reporting (physical uplink control channel (“PUCCH”)) or semi-persistent CSI reporting (PUSCH or PUCCH) or aperiodic reporting (PUSCH).

In some embodiments, there may be priority reporting for Part 2 CSI. It should be noted that multiple CSI reports may be transmitted as shown in Table 1.

TABLE 1
CSI Reports priority ordering

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report
N_{Rep}, if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

It should be noted that the priority of the N_{Rep} CSI reports are based on the following. A CSI report corresponding to one CSI reporting configuration for one cell may have higher priority compared with another CSI report corresponding to one other CSI reporting configuration for the same cell. CSI reports intended to one cell may have higher priority compared with other CSI reports intended to another cell. CSI reports may have higher priority based on the CSI report content (e.g., CSI reports carrying L1-RSRP information have higher priority). CSI reports may have higher priority based on their type (e.g., whether the CSI report is aperiodic, semi-persistent or periodic, and whether the report is sent via PUSCH or PUCCH, may impact the priority of the CSI report).

In light of that, CSI reports may be prioritized as follows, where CSI reports with lower IDs have higher priority: Pri_{iCSI}(y, k, c, s)=2·N_{cells}·Mₛ·y+N_{cells}·Mₛ·k+Mₛ·c+s, s: CSI reporting configuration index, and Ms: Maximum number of CSI reporting configurations, c: Cell index, and Ncells: Number of serving cells, k: 0 for CSI reports carrying layer 1 (“L1”) reference signal received power (“RSRP”) (“L1-RSRP”) or L1 signal-to-interference and noise ratio (“SINR”) (“L1-SINR”), 1 otherwise, y: 0 for aperiodic reports, 1 for semi-persistent reports on PUSCH, 2 for semi-persistent reports on PUCCH, 3 for periodic reports.

In certain embodiments, there may be a triggering of aperiodic CSI reporting on PUSCH. In such embodiments, a UE needs to report needed CSI information for a network using a CSI framework. The triggering mechanism between a report setting and a resource setting may be summarized as in Table 2.

TABLE 2
Triggering Mechanism Between a Report Setting and a Resource Setting

| | | Periodic CSI | | AP CSI |
|---|---|---|---|---|
| | | reporting | SP CSI reporting | Reporting |
| Time Domain | Periodic CSI- | RRC | MAC control | DCI |
| Behavior of | RS | configured | element (“CE”) | |
| Resource Setting | | | (PUCCH) | |
| | | | DCI (PUSCH) | |
| | SP CSI-RS | Not Supported | MAC CE (PUCCH) | DCI |
| | | | DCI (PUSCH) | |
| | AP CSI-RS | Not Supported | Not Supported | DCI |

In various embodiments, all associated resource settings for a CSI report setting need to have the same time domain behavior, such as: 1) periodic CSI-RS and/or IM resource and CSI reports are always assumed to be present and active once configured by RRC; 2) aperiodic and semi-persistent CSI-RS and/or IM resources and CSI reports needs to be explicitly triggered or activated; 3) aperiodic CSI-RS and/or IM resources and aperiodic CSI reports, the triggering is done jointly by transmitting a DCI Format 0-1; and/or 4) semi-persistent CSI-RS and/or IM resources and semi-persistent CSI reports are independently activated.

In certain embodiments, for aperiodic CSI-RS and/or IM resources and aperiodic CSI reports, the triggering is done jointly by transmitting a DCI Format 0-1. The DCI Format 0_1 contains a CSI request field (e.g., 0 to 6 bits). A non-zero request field points to a so-called aperiodic trigger state configured by RRC. An aperiodic trigger state in turn is defined as a list of up to 16 aperiodic CSI report settings, identified by a CSI report setting ID for which the UE calculates simultaneously CSI and transmits it on the scheduled PUSCH transmission.

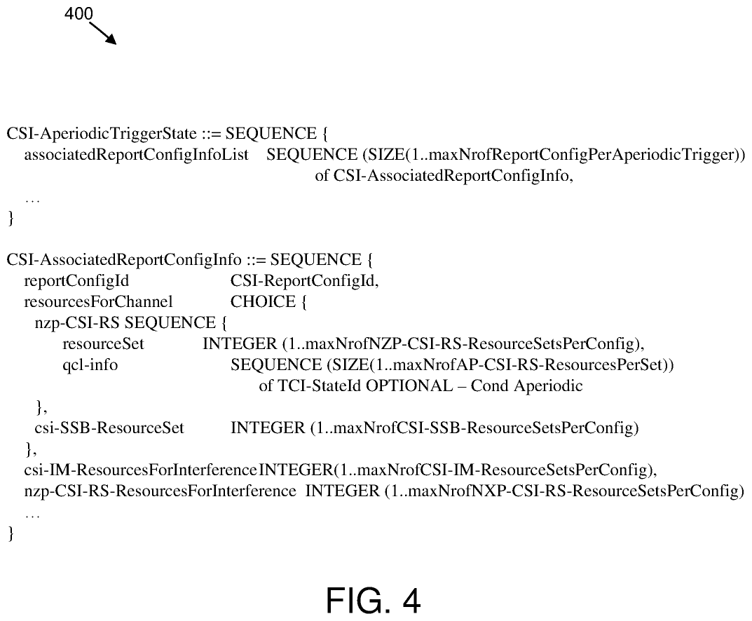

In some embodiments, if the CSI report setting is linked with an aperiodic resource setting (e.g., can comprise multiple resource sets), the aperiodic non-zero power (“NZP”) CSI-RS resource set for channel measurement, the aperiodic CSI interference management (“IM”) (“CSI-IM”) resource set (e.g., if used) and the aperiodic NZP CSI-RS resource set for IM (e.g., if used) to use for a given CSI report setting are also included in the aperiodic trigger state definition (e.g., see FIG. 4). For aperiodic NZP CSI-RS, the QCL source to use is also configured in the aperiodic trigger state. The UE assumes that the resources used for the computation of the channel and interference can be processed with the same spatial filter e.g., quasi-co-located with respect to “QCL-TypeD.”

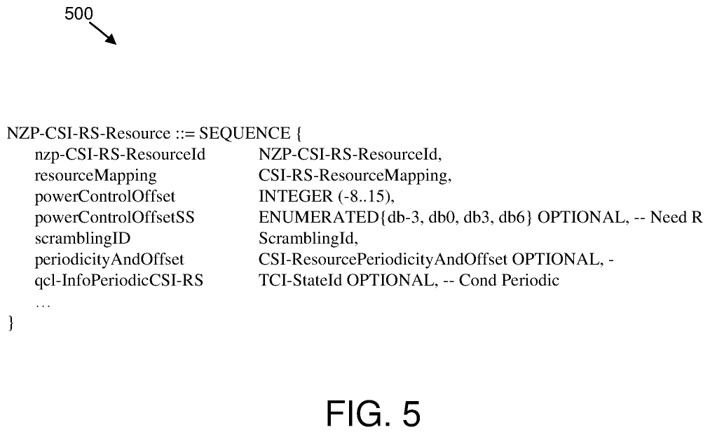

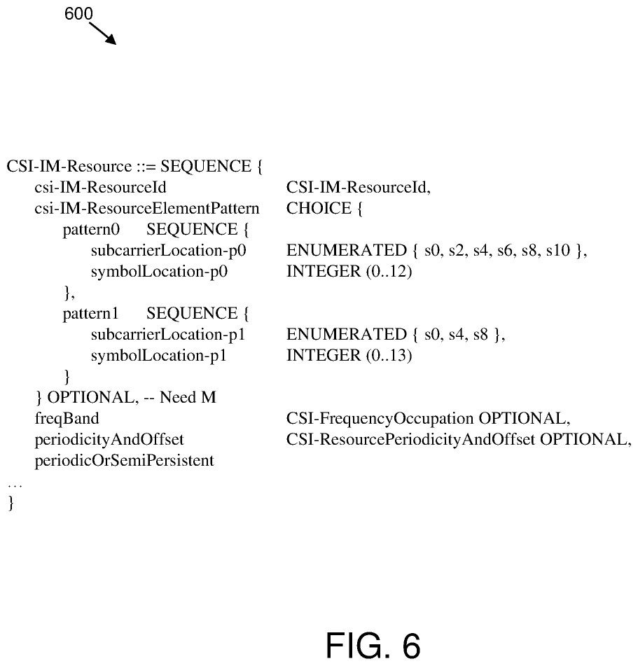

FIG. 4 is a schematic block diagram illustrating one embodiment of code 400 for an aperiodic trigger state that indicates a resource set and QCL information. FIG. 5 is a schematic block diagram illustrating one embodiment of code 500 that describes an RRC configuration for an NZP-CSI-RS resource. FIG. 6 is a schematic block diagram illustrating one embodiment of code 600 that describes an RRC configuration for a CSI-IM resource.

In Table 3 there is a summary of a type of uplink channels used for CSI reporting as a function of the CSI codebook type.

TABLE 3
Uplink Channels Used for CSI Reporting
as a Function of the CSI Codebook Type

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

In certain embodiments, such as for aperiodic CSI reporting, PUSCH-based reports are divided into two CSI parts: CSI Part 1 and CSI Part 2. The reason for this is that the size of CSI payload varies significantly, and, therefore, a worst-case uplink control information (“UCI”) payload size design would result in large overhead. CSI Part 1 has a fixed payload size (and can be decoded by the gNB without prior information) and contains the following: rank indicator (“RI”) (if reported), CSI-RS resource index (“CRI”) (if reported), channel quality indicator (“CQI”) for the first codeword, and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered.

In some embodiments, CSI reports are prioritized according to: 1) time-domain behavior and physical channel, where more dynamic reports are given precedence over less dynamic reports and PUSCH has precedence over PUCCH; 2) CSI content, where beam reports (e.g., L1-RSRP reporting) has priority over regular CSI reports; 3) the serving cell to which the CSI corresponds (e.g., in case of a carrier aggregation (“CA”) operation)-CSI corresponding to the PCell has priority over CSI corresponding to Scells; and/or 4) the reportConfigID.

In various embodiments, a CSI report may include a CQI report quantity corresponding to channel quality assuming a maximum target transport block error rates, which indicates a modulation order, a code rate, and a corresponding spectral efficiency associated with the modulation order and code rate pair. Examples of the maximum transport block error rates are 0.1 and 0.00001. The modulation order may vary from quadrature phase-shift keying (“QPSK”) up to 1024 quadrature amplitude modulation (“QAM”), whereas the code rate may vary from 30/1024 up to 948/1024. One example of a CQI table for a 4-bit CQI indicator that identifies a possible CQI value with the corresponding modulation order, code rate and efficiency is provided in.

TABLE 4
4-bit CQI table

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In certain embodiments, a CQI value may be reported in two formats: 1) a wideband format, wherein one CQI value is reported corresponding to each physical downlink shared channel (“PDSCH”) transport block; and 2) a subband format, wherein one wideband CQI value is reported for the entire transport block, in addition to a set of subband CQI values corresponding to CQI subbands on which the transport block is transmitted. CQI subband sizes are configurable, and depends on the number of physical resource blocks (“PRBs”) in a bandwidth part, as shown in Error! Reference source not found.

TABLE 5
Configurable subband sizes for a given
bandwidth part (“BWP”) size

| Bandwidth part (PRBs) | Subband size (PRBs) |
|---|---|
| 24-72 | 4, 8 |
| 73-144 | 8, 16 |
| 145-275 | 16, 32 |

In some embodiments, if a higher layer parameter cqi-BitsPerSubband in a CSI reporting setting CSI-ReportConfig is configured, subband CQI values are reported in a full form, (e.g., using 4 bits for each subband CQI based on a CQI table such as via

). If the higher layer parameter cqi-BitsPerSubband in CSI-ReportConfig is not configured, for each subband s, a 2-bit sub-band differential CQI value may be reported and may be defined as:

Sub-band Offset level(s)=sub-band CQI index(s)-wideband CQI index.

The mapping from the 2-bit sub-band differential CQI values to the offset level is shown in Error! Reference source not found.

TABLE 6
Mapping subband differential CQI value to offset level

| Sub-band differential CQI value | Offset level |
|---|---|
| 0 | 0 |
| 1 | 1 |
| 2 | ≥2 |
| 3 | ≤−1 |

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mm Wave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qel-Type may take one of the following values: 1) ‘QCL-TypeA’: {Doppler shift, Doppler spread, average delay, delay spread}; 2) ‘QCL-TypeB’: {Doppler shift, Doppler spread}: 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mm Wave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In some embodiments described herein, an UL TCI state is provided if a device is configured with separate DL and/or UL TCI by RRC signaling. The UL TCI state may include a source reference signal which provides a reference for determining an UL spatial domain transmission filter for the UL transmission (e.g., dynamic-grant and/or configured-grant based PUSCH, dedicated PUCCH resources) in a component carrier (“CC”) or across a set of configured CCs and/or BWPs.

In various embodiments described herein, a joint DL and/or UL (“DL/UL”) TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (“PDCCH”) and/or PDSCH) and is used to determine an UL spatial transmission filter (e.g., for UE-dedicated PUSCH and/or PUCCH) for a CC or across a set of configured CCs and/or BWPs. In one example, the UL spatial transmission filter is derived from the RS of DL QCL Type D in a joint TCI state. The spatial setting of the UL transmission may be according to the spatial relation with a reference to the source RS configured with qel-Type set to ‘typeD’ in the joint TCI state.

As used herein, the following notions may be used interchangeably: transmit-receive point (“TRP”), panel, set of antennas, set of antenna ports, uniform linear array, cell, node, radio head, communication (e.g., signals and/or channels) associated with a control resource set (“CORESET”) pool, communication associated with a TCI state from a transmission configuration including at least two TCI states.

Moreover, a codebook type used for precoding matrix indicator (“PMI”) reporting may be arbitrary (e.g., there may be flexibility to use different codebook types such as different Type-II codebooks.

Furthermore, unless otherwise stated, a NZP CSI-RS resource set configured with a higher-layer parameter ‘trs-info’ is referred to as a TRS, and an NZP CSI-RS resource that is not configured with either higher-layer parameters ‘trs-info’ or ‘repetition’ is referred to as CSI-RS.

As used herein, the terms channel coherence and channel correlation over time may be used interchangeably.

Several different embodiments are described herein. According to possible embodiments, one or more elements or features from one or more embodiments may be combined.

In a first set of embodiments, there may be TDCP reporting to a network. In such embodiments, a UE is configured with reporting TDCP parameters to the network via a TDCP report (e.g., a network node) via a report transmitted in a physical uplink channel.

In a first embodiment of the first set of embodiments, the TDCP report is transmitted over a PUSCH or a PUCCH.

In a second embodiment of the first set of embodiments, the TDCP report is configured with a time-domain behavior that is set to: periodic, aperiodic, or semi-persistent. In one example, the TDCP report is configured with a periodic time-domain behavior, wherein a periodicity of the TDCP report is no less than a periodicity of a TRS associated with the TDCP report.

In a third embodiment of the first set of embodiments, the TDCP report corresponds to a CSI report configured via a CSI reporting setting including a report quantity that is set to a time-domain and/or Doppler-domain indication (e.g., Doppler indication, Time-domain indication, etc.).

In a fourth embodiment of the first set of embodiments, the TDCP report is a standalone report that is configured via a TDCP reporting setting.

In a fifth embodiment of the first set of embodiments, the TDCP report is configured with at least one TRS (e.g., at least one NZP CSI-RS resource set that is configured with trs-info set to true).

In a second set of embodiments, there may be a reporting of channel temporal coherence strength. In such embodiments, the UE is configured with reporting TDCP parameters in a TDCP report based on at least one TRS.

In one example, symbols s1, s2, s3, s4 are transmitted at time t1, t2, t3, t4, respectively. In a first alternative of this example, autocorrelation values between s1, s2, and s1, s3, and s1, s4 may be indicated. Further, in a second alternative, the symbol whose autocorrelation with s1 is approximately 0.9 may be indicated.

In a first embodiment of the second set of embodiments, the TDCP report includes at least one value corresponding to a number of slots that indicates a time period over which the channel correlation over time remains strong. In a first example of the first embodiment, the value is in terms of a number of slots. In a second example of the first embodiment, the value is in terms of a symbol index in time corresponding to symbols of a TRS. In a third example, the value is in terms of a TRS index in time corresponding to multiple TRS transmissions corresponding to different TRSs with a different CSI-RS resource set ID, multiple TRS transmissions over multiple periods of time based on a periodicity value of TRS transmission, or a combination thereof.

In a second embodiment of the second set of embodiments, the TDCP report includes a subset of parameters corresponding to the channel correlation over time, such as: a first parameter corresponding to a strong channel correlation interval, a second parameter corresponding to a moderate channel correlation interval, and a third parameter corresponding to a weak channel correlation interval. In a first example of the second embodiment, a channel autocorrelation value in time between two TRS transmission occasions that is no less than a value 0.9 is considered a strong channel correlation interval. In a second example of the second embodiment, a channel autocorrelation value in time between two TRS transmission occasions that is no less than a value 0.5 is considered a moderate channel correlation interval. In a third example of the second embodiment, a channel autocorrelation value in time between two TRS transmission occasions that is smaller than a value 0.5 is considered a weak channel correlation interval.

In a third embodiment of the second set of embodiments, a measurement of the channel correlation is configured to be reported based on one format of a group of configurable formats, including: a first format corresponding to reporting the channel correlation based on a burst of multi-TRSs (e.g., channel correlation is measured across different TRS transmissions), and a second format corresponding to reporting the channel correlation based on a single TRS (e.g., channel correlation is measured across different symbols of a same TRS transmission), and a third format corresponding to reporting the channel correlation based on both symbols of a same TRS transmission and symbols of different TRS transmissions. In one example of the third embodiment, the first format corresponding to reporting the channel correlation is based on a burst of multi-TRSs is the default format.

In a fourth embodiment of the second set of embodiments, the TDCP report includes at least one value corresponding to a time-domain correlation value between a reference point and a second point. In a first example of the fourth embodiment, the reference point is a reference symbol of a TRS, and the second point is a symbol of a TRS that is subsequent to the reference symbol of the TRS. In a second example, the reference point is a first TRS transmission of a burst of periodic TRS transmissions, and the second point is a second TRS of the burst of periodic TRS transmissions that is subsequent to the first TRS transmission of the burst of periodic TRS transmissions. In a third example of the fourth embodiment, the at least one value corresponding to the time-domain correlation value between the reference point and the second point is selected from a codebook of values whose maximum value is one, and minimum value is zero, wherein the codebook of values is based on a uniformly spaced set of values in a linear domain, e.g.,

$$\{ 1 , \frac{5}{6} , \frac{4}{6} , \frac{3}{6} , \frac{2}{6} , \frac{1}{6} , 0 \} .$$

Alternatively, the codebook of values is based on a uniformly spaced set of values in a logarithmic domain, e.g.,

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} \} .$$

In a fifth embodiment of the second set of embodiments, the time-domain correlation value between two points is calculated via a cumulative approach (e.g., differential correlation value). In a first example of the fifth embodiment, for three consecutive TRS transmissions t₀, t₁, t₂, respectively, two correlation values c₁, c₂ are reported, wherein the correlation between t₀ and f₁ corresponds to parameter c₁, and the correlation between t₀ and t₂ corresponds to a product of the parameters c₁ and c₂, i.e., c₁.c₂.

In a third set of embodiments, there may be TDCP reporting settings. In such embodiments, the UE reports a TDCP report based on a set of configuration parameters transmitted by the network, either in a form of a CSI reporting setting corresponding to a report quantity that is set to a time-domain and/or Doppler-domain indication, or in a form of a standalone TDCP reporting setting corresponding to the TDCP report. Different embodiments are described herein. According to possible embodiments, one or more elements or features from one or more of the described embodiments may be combined.

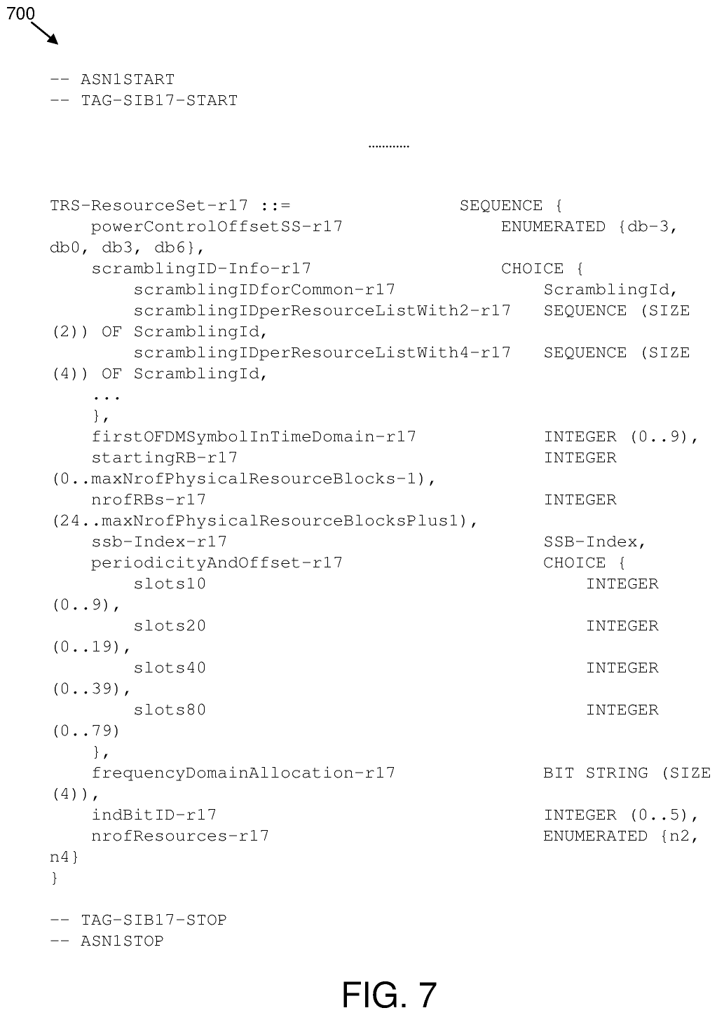

In a first embodiment of the third set of embodiments, the set of TDCP configuration parameters includes an indicator of an ID of one NZP CSI-RS resource set that is configured with trs-info (e.g., a TRS), wherein the NZP CSI-RS resource set is used to measure parameters that are to be reported in the TDCP report (e.g., parameters corresponding to the channel correlation in time). In a first example of the first embodiment, the TRS is configured with a periodic time-domain behavior. In a second example of the first embodiment, the TRS is configured with a release based TRS. An example of a configuration of a release based TRS may be found in FIG. 7. Specifically, FIG. 7 is a schematic block diagram illustrating one embodiment of code 700 for a TRS resource set configuration.

In a second embodiment of the third set of embodiments, the set of TDCP configuration parameters includes an indicator of IDs of two NZP CSI-RS resource sets that are configured with trs-info (e.g., two TRSs), wherein at least one TRS of the two TRSs is used to measure parameters that are to be reported in the TDCP report (e.g., parameters corresponding to the channel correlation in time). In a first example of the second embodiment, each TRS of the at least one TRS is configured with a periodic time-domain behavior. In a second example of the second embodiment, the two TRSs are configured with a same periodicity value corresponding to a periodicity-and-offset parameter of the NZP CSI-RS resource set configured with trs-info, and a different offset value corresponding to a periodicity-and-offset parameter of the NZP CSI-RS resource set configured with trs-info. In a third example of the second embodiment, the two TRSs are configured with a same power control offset value.

In a third embodiment of the third set of embodiments, the TDCP report has a fixed payload size. In one example of the third embodiment, zero-padding bits are added to the TDCP report to ensure the TDCP report has a fixed overhead size, wherein the fixed size is one of fixed or higher-layer configured. In a first example of the third embodiment, the zero-padding bits are appended to the TDCP report due to a different bitwidth of a parameter of the TDCP report based on a given configuration or reported value. In a second example of the third embodiment, the zero-padding bits are appended to the TDCP report due to not configuring a subset of parameters of the TDCP report. In a third example of the third embodiment, the zero-padding bits are appended to the TDCP report due to a subset of parameters of the TDCP report having a nulled value.

In a fourth set of embodiments, there may be an explicit CSI reporting setting parameter reporting in a TDCP report. In such embodiments, a UE reports parameters in the TDCP report that assist a network to configure and/or re-configure CSI reporting setting parameters. Different embodiments that describe the corresponding TDCP report parameters are provided herein. According to a possible embodiment, one or more elements or features from one or more of the described embodiments may be combined.

In a first embodiment of the fourth set of embodiments, an indicator of a maximum rank indicator, an RI-restriction configuration assistance, or a combination thereof is included in the TDCP report.

In a second embodiment of the fourth set of embodiments, an indicator field corresponding to a PMI codebook type, a codebook sub-type, or a combination thereof is included in the TDCP report. In one example of the second embodiment, the UE indicates one of a ‘Rel-15 Type-I single panel’ codebook, or a ‘Rel-18 Type-II high-speed’ codebook in the TDCP report.

In a third embodiment of the fourth set of embodiments, an indicator field corresponding to a subset of a set of CSI report quantities is included in the TDCP report, wherein the set of CSI report quantities includes CRI, rank indicator (“RI”), PMI, CQI, layer index (“LI”), L1-RSRP, L1-SINR and a Doppler and/or time-domain correlation indicator.

In a fourth embodiment of the fourth set of embodiments, an indicator field corresponding to a CQI, PMI and/or Doppler super-slot size, or, alternatively, a number of slots in a CQI, PMI, and/or Doppler slot group is included in the TDCP report.

In a fifth embodiment of the fourth set of embodiments, an indicator field corresponding to a total number of super slots, or, alternatively, a number of slot groups is included in the TDCP report.

In a sixth embodiment of the fourth set of embodiments, a format of one or more of a CQI and/or PMI is included in the TDCP report. In one example of the sixth embodiment, the UE indicates in the TDCP report one of a ‘wideband’ or a ‘subband’ format corresponding to a CQI value.

In a seventh embodiment of the fourth set of embodiments, an indicator field that indicates whether a QCL relationship corresponding to Doppler shift, Doppler spread, average delay, delay spread, and/or spatial relation holds is included in the TDCP report.

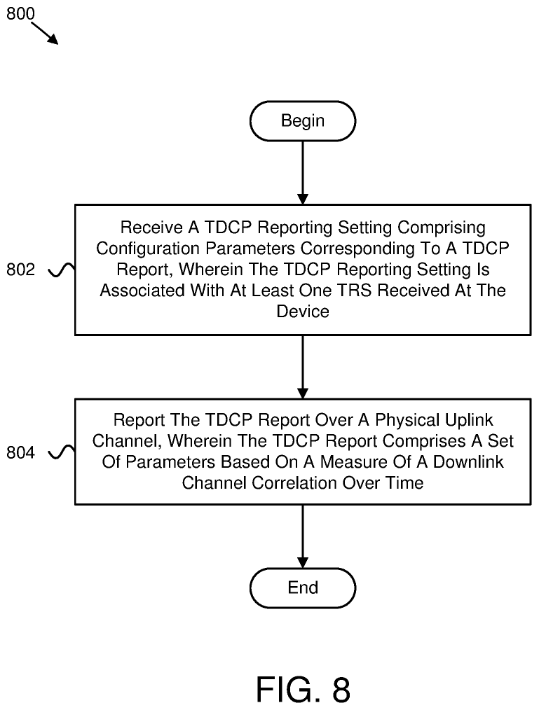

FIG. 8 is a flow chart diagram illustrating one embodiment of a method 800 for reporting a TDCP report. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a device, a TDCP reporting setting including configuration parameters corresponding to a TDCP report. The TDCP reporting setting is associated with at least one TRS received at the device. In some embodiments, the method 800 includes reporting 804 the TDCP report over a physical uplink channel. The TDCP report includes a set of parameters based on a measure of a downlink channel correlation over time.

In certain embodiments, the TRS corresponds to a NZP CSI-RS resource set configured with a TRS information configuration parameter. In some embodiments, the TDCP report is transmitted over a PUCCH based on a time-domain behavior set to periodic or semi-persistent. In various embodiments, a periodicity value of reporting the TDCP report is no less than a periodicity of receiving the at least one TRS at the device.

In one embodiment, the TDCP report is transmitted over a PUSCH based on a time-domain behavior set to aperiodic or semi-persistent. In certain embodiments, the TDCP report corresponds to a CSI report, the TDCP reporting setting corresponds to a CSI reporting setting, and a report quantity associated with the CSI reporting setting is set to a time-domain correlation indication. In some embodiments, the CSI reporting setting comprises an ID of the at least one TRS.

In various embodiments, the set of parameters corresponding to the TDCP report comprises at least one parameter indicating a time interval over which the channel correlation is greater than a largest threshold value of a set of at least one threshold value. In one embodiment, the time interval corresponds to a number of slots. In certain embodiments, the time interval corresponds to a symbol index in time with respect to symbols of the at least one TRS.

In some embodiments, the time interval corresponds to a TRS index in time with respect to a sequence of periodic or semi-persistent TRS transmissions over time. In various embodiments, the set of parameters corresponding to the TDCP report comprises a parameter indicating a time interval over which the channel correlation is within two different threshold values. In other embodiments, the set of parameters corresponding to the TDCP report comprises a parameter indicating a time interval over which the channel correlation is less than a lowest threshold value of a set of at least one threshold value. In one embodiment, the set of parameters corresponding to the TDCP report comprises a set of time-domain correlation values corresponding to a reference TRS unit and a second TRS unit.

In certain embodiments, the reference TRS unit corresponds to: a symbol of a TRS; a TRS transmission of a sequence of periodic TRS transmissions; a TRS transmission of a sequence of semi-persistent TRS transmissions; or a combination thereof. In some embodiments, the set of time-domain correlation values are selected from a codebook of correlation values. In various embodiments, codewords of the codebook of correlation values are uniformly spaced with respect to: a linear domain; or a logarithmic domain.

In one embodiment, channel correlation values are computed in a differential format with respect to two consecutive TRS units. In certain embodiments, the TDCP report is associated with a fixed payload size. In some embodiments, a set of zero-valued bits are appended to the TDCP report so a size of the TDCP report meets the fixed payload size.

In various embodiments, the TDCP reporting setting is associated with a TRS configured with a TRS resource set configuration, and the TRS resource set configuration further comprises: an indicator of a periodicity and an offset value; an indicator of a power-control offset value; an indicator of a number of resources of the TRS; or a combination thereof. In one embodiment, the TDCP reporting setting is associated with two TRSs.

In certain embodiments, the two TRSs are configured with: a same power-control offset value; a same periodicity value; a different offset value; or a combination thereof. In some embodiments, the set of parameters corresponding to the TDCP report comprises: a maximum rank indicator; an indication of a rank indicator restriction; a codebook type corresponding to a PMI; a subset of a set of report quantities, the set of report quantities including a CSI-RS CRI, a RI, a PMI, a LI, a CQI, a L1-RSRP, an L1-SINR; an indicator of a super slot or slot group size in terms of a number of slots; an indicator of a number of super slots or slot groups; an indicator of a format of the PMI, an indicator of a format of the CQI, an indicator field that indicates whether a QCL relationship holds over two time instants corresponding to Doppler shift, Doppler spread, average delay, delay spread, spatial relation, or a combination thereof; or a combination thereof.

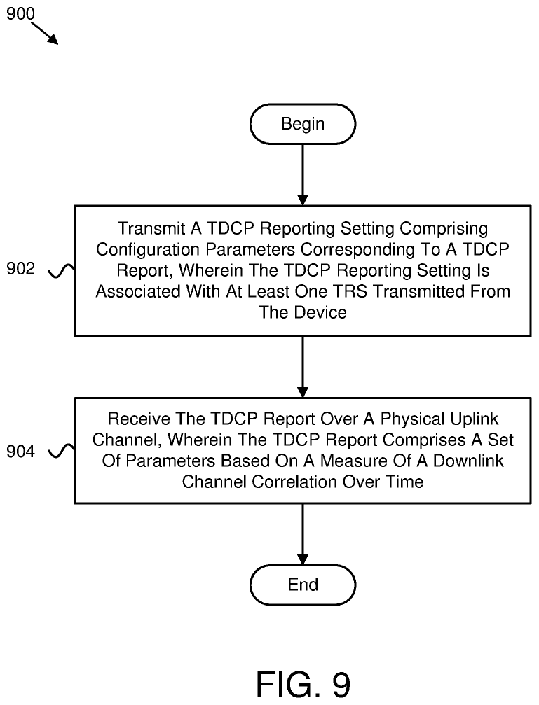

FIG. 9 is a flow chart diagram illustrating another embodiment of a method 900 for reporting a TDCP report. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes transmitting 902, at a device, a TDCP reporting setting including configuration parameters corresponding to a TDCP report. The TDCP reporting setting is associated with at least one TRS transmitted from the device. In some embodiments, the method 900 includes receiving 904 the TDCP report over a physical uplink channel. The TDCP report includes a set of parameters based on a measure of a downlink channel correlation over time.

In certain embodiments, the TRS corresponds to a NZP CSI-RS resource set configured with a TRS information configuration parameter. In some embodiments, the TDCP report is transmitted over a PUCCH based on a time-domain behavior set to periodic or semi-persistent. In various embodiments, a periodicity value of reporting the TDCP report is no less than a periodicity of transmitting the at least one TRS from the device.

In one embodiment, the TDCP report is transmitted over a PUSCH based on a time-domain behavior set to aperiodic or semi-persistent. In certain embodiments, the TDCP report corresponds to a CSI report, the TDCP reporting setting corresponds to a CSI reporting setting, and a report quantity associated with the CSI reporting setting is set to a time-domain correlation indication. In some embodiments, the CSI reporting setting comprises an ID of the at least one TRS.

In various embodiments, the set of parameters corresponding to the TDCP report comprises at least one parameter indicating a time interval over which the channel correlation is greater than a largest threshold value of a set of at least one threshold value. In one embodiment, the time interval corresponds to a number of slots. In certain embodiments, the time interval corresponds to a symbol index in time with respect to symbols of the at least one TRS.

In some embodiments, the time interval corresponds to a TRS index in time with respect to a sequence of periodic or semi-persistent TRS transmissions over time. In various embodiments, the set of parameters corresponding to the TDCP report comprises a parameter indicating a time interval over which the channel correlation is within two different threshold values. In other embodiments, the set of parameters corresponding to the TDCP report comprises a parameter indicating a time interval over which the channel correlation is less than a lowest threshold value of a set of at least one threshold value. In one embodiment, the set of parameters corresponding to the TDCP report comprises a set of time-domain correlation values corresponding to a reference TRS unit and a second TRS unit.

In certain embodiments, the reference TRS unit corresponds to: a symbol of a TRS; a TRS transmission of a sequence of periodic TRS transmissions; a TRS transmission of a sequence of semi-persistent TRS transmissions; or a combination thereof. In some embodiments, the set of time-domain correlation values are selected from a codebook of correlation values. In various embodiments, codewords of the codebook of correlation values are uniformly spaced with respect to: a linear domain; or a logarithmic domain.

In one embodiment, channel correlation values are computed in a differential format with respect to two consecutive TRS units. In certain embodiments, the TDCP report is associated with a fixed payload size. In some embodiments, a set of zero-valued bits are appended to the TDCP report so a size of the TDCP report meets the fixed payload size.

In various embodiments, the TDCP reporting setting is associated with a TRS configured with a TRS resource set configuration, and the TRS resource set configuration further comprises: an indicator of a periodicity and an offset value; an indicator of a power-control offset value; an indicator of a number of resources of the TRS; or a combination thereof. In one embodiment, the TDCP reporting setting is associated with two TRSs.

In certain embodiments, the two TRSs are configured with: a same power-control offset value; a same periodicity value; a different offset value; or a combination thereof. In some embodiments, the set of parameters corresponding to the TDCP report comprises: a maximum rank indicator; an indication of a rank indicator restriction; a codebook type corresponding to a PMI; a subset of a set of report quantities, the set of report quantities including a CSI-RS CRI, a RI, a PMI, a LI, a CQI, a L1-RSRP, an L1-SINR; an indicator of a super slot or slot group size in terms of a number of slots; an indicator of a number of super slots or slot groups; an indicator of a format of the PMI, an indicator of a format of the CQI, an indicator field that indicates whether a QCL relationship holds over two time instants corresponding to Doppler shift, Doppler spread, average delay, delay spread, spatial relation, or a combination thereof; or a combination thereof.

In one embodiment, an apparatus for wireless communication, the apparatus comprises: a processor; and a memory coupled with the processor, the processor configured to cause the apparatus to: receive a TDCP reporting setting comprising configuration parameters corresponding to a TDCP report, wherein the TDCP reporting setting is associated with at least one TRS received at the apparatus; and receive the TDCP report over a physical uplink channel, wherein the TDCP report comprises a set of parameters based on a measure of a downlink channel correlation over time.

In certain embodiments, the TRS corresponds to a NZP CSI-RS resource set configured with a TRS information configuration parameter.

In some embodiments, the TDCP report is transmitted over a PUCCH based on a time-domain behavior set to periodic or semi-persistent.

In various embodiments, a periodicity value of reporting the TDCP report is no less than a periodicity of receiving the at least one TRS at the apparatus.

In one embodiment, the TDCP report is transmitted over a PUSCH based on a time-domain behavior set to aperiodic or semi-persistent.

In certain embodiments, the TDCP report corresponds to a CSI report, the TDCP reporting setting corresponds to a CSI reporting setting, and a report quantity associated with the CSI reporting setting is set to a time-domain correlation indication.

In some embodiments, the CSI reporting setting comprises an ID of the at least one TRS.

In various embodiments, the set of parameters corresponding to the TDCP report comprises at least one parameter indicating a time interval over which the channel correlation is greater than a largest threshold value of a set of at least one threshold value.

In one embodiment, the time interval corresponds to a number of slots.

In certain embodiments, the time interval corresponds to a symbol index in time with respect to symbols of the at least one TRS.

In some embodiments, the time interval corresponds to a TRS index in time with respect to a sequence of periodic or semi-persistent TRS transmissions over time.

In various embodiments, the set of parameters corresponding to the TDCP report comprises a parameter indicating a time interval over which the channel correlation is within two different threshold values. In other embodiments, the set of parameters corresponding to the TDCP report comprises a parameter indicating a time interval over which the channel correlation is less than a lowest threshold value of a set of at least one threshold value.

In one embodiment, the set of parameters corresponding to the TDCP report comprises a set of time-domain correlation values corresponding to a reference TRS unit and a second TRS unit.

In certain embodiments, the reference TRS unit corresponds to: a symbol of a TRS; a TRS transmission of a sequence of periodic TRS transmissions; a TRS transmission of a sequence of semi-persistent TRS transmissions; or a combination thereof.

In some embodiments, the set of time-domain correlation values are selected from a codebook of correlation values.

In various embodiments, codewords of the codebook of correlation values are uniformly spaced with respect to: a linear domain; or a logarithmic domain.

In one embodiment, channel correlation values are computed in a differential format with respect to two consecutive TRS units.

In certain embodiments, the TDCP report is associated with a fixed payload size.

In some embodiments, a set of zero-valued bits are appended to the TDCP report so a size of the TDCP report meets the fixed payload size.

In various embodiments, the TDCP reporting setting is associated with a TRS configured with a TRS resource set configuration, and the TRS resource set configuration further comprises: an indicator of a periodicity and an offset value; an indicator of a power-control offset value; an indicator of a number of resources of the TRS; or a combination thereof.

In one embodiment, the TDCP reporting setting is associated with two TRSs.

In certain embodiments, the two TRSs are configured with: a same power-control offset value; a same periodicity value; a different offset value; or a combination thereof.

In some embodiments, the set of parameters corresponding to the TDCP report comprises: a maximum rank indicator; an indication of a rank indicator restriction; a codebook type corresponding to a PMI; a subset of a set of report quantities, the set of report quantities including a CSI-RS CRI, a RI, a PMI, a LI, a CQI, a L1-RSRP, an L1-SINR; an indicator of a super slot or slot group size in terms of a number of slots; an indicator of a number of super slots or slot groups; an indicator of a format of the PMI, an indicator of a format of the CQI, an indicator field that indicates whether a QCL relationship holds over two time instants corresponding to Doppler shift, Doppler spread, average delay, delay spread, spatial relation, or a combination thereof; or a combination thereof.

In one embodiment, a method at a device, the method comprises: receiving a TDCP reporting setting comprising configuration parameters corresponding to a TDCP report, wherein the TDCP reporting setting is associated with at least one TRS received at the device; and reporting the TDCP report over a physical uplink channel, wherein the TDCP report comprises a set of parameters based on a measure of a downlink channel correlation over time.

In certain embodiments, the TRS corresponds to a NZP CSI-RS resource set configured with a TRS information configuration parameter.

In some embodiments, the TDCP report is transmitted over a PUCCH based on a time-domain behavior set to periodic or semi-persistent.

In various embodiments, a periodicity value of reporting the TDCP report is no less than a periodicity of receiving the at least one TRS at the device.

In one embodiment, the TDCP report is transmitted over a PUSCH based on a time-domain behavior set to aperiodic or semi-persistent.

In certain embodiments, the TDCP report corresponds to a CSI report, the TDCP reporting setting corresponds to a CSI reporting setting, and a report quantity associated with the CSI reporting setting is set to a time-domain correlation indication.

In some embodiments, the CSI reporting setting comprises an ID of the at least one TRS.

In various embodiments, the set of parameters corresponding to the TDCP report comprises at least one parameter indicating a time interval over which the channel correlation is greater than a largest threshold value of a set of at least one threshold value.

In one embodiment, the time interval corresponds to a number of slots.

In certain embodiments, the time interval corresponds to a symbol index in time with respect to symbols of the at least one TRS.

In some embodiments, the time interval corresponds to a TRS index in time with respect to a sequence of periodic or semi-persistent TRS transmissions over time.

In various embodiments, the set of parameters corresponding to the TDCP report comprises a parameter indicating a time interval over which the channel correlation is within two different threshold values. In other embodiments, the set of parameters corresponding to the TDCP report comprises a parameter indicating a time interval over which the channel correlation is less than a lowest threshold value of a set of at least one threshold value.

In one embodiment, the set of parameters corresponding to the TDCP report comprises a set of time-domain correlation values corresponding to a reference TRS unit and a second TRS unit.

In certain embodiments, the reference TRS unit corresponds to: a symbol of a TRS; a TRS transmission of a sequence of periodic TRS transmissions; a TRS transmission of a sequence of semi-persistent TRS transmissions; or a combination thereof.

In some embodiments, the set of time-domain correlation values are selected from a codebook of correlation values.

In various embodiments, codewords of the codebook of correlation values are uniformly spaced with respect to: a linear domain; or a logarithmic domain.

In one embodiment, channel correlation values are computed in a differential format with respect to two consecutive TRS units.

In certain embodiments, the TDCP report is associated with a fixed payload size.

In some embodiments, a set of zero-valued bits are appended to the TDCP report so a size of the TDCP report meets the fixed payload size.

In various embodiments, the TDCP reporting setting is associated with a TRS configured with a TRS resource set configuration, and the TRS resource set configuration further comprises: an indicator of a periodicity and an offset value; an indicator of a power-control offset value; an indicator of a number of resources of the TRS; or a combination thereof.

In one embodiment, the TDCP reporting setting is associated with two TRSs.

In certain embodiments, the two TRSs are configured with: a same power-control offset value; a same periodicity value; a different offset value; or a combination thereof.

In some embodiments, the set of parameters corresponding to the TDCP report comprises: a maximum rank indicator; an indication of a rank indicator restriction; a codebook type corresponding to a PMI; a subset of a set of report quantities, the set of report quantities including a CSI-RS CRI, a RI, a PMI, a LI, a CQI, a L1-RSRP, an L1-SINR; an indicator of a super slot or slot group size in terms of a number of slots; an indicator of a number of super slots or slot groups; an indicator of a format of the PMI, an indicator of a format of the CQI, an indicator field that indicates whether a QCL relationship holds over two time instants corresponding to Doppler shift, Doppler spread, average delay, delay spread, spatial relation, or a combination thereof; or a combination thereof.

In one embodiment, an apparatus for wireless communication, the apparatus comprises: a processor; and a memory coupled to the processor, the processor configured to cause the apparatus to: transmit a TDCP reporting setting comprising configuration parameters corresponding to a TDCP report, wherein the TDCP reporting setting is associated with at least one TRS transmitted from the apparatus; and receive the TDCP report over a physical uplink channel, wherein the TDCP report comprises a set of parameters based on a measure of a downlink channel correlation over time.

In certain embodiments, the TRS corresponds to a NZP CSI-RS resource set configured with a TRS information configuration parameter.

In some embodiments, the TDCP report is transmitted over a PUCCH based on a time-domain behavior set to periodic or semi-persistent.

In various embodiments, a periodicity value of reporting the TDCP report is no less than a periodicity of transmitting the at least one TRS from the apparatus.

In one embodiment, the TDCP report is transmitted over a PUSCH based on a time-domain behavior set to aperiodic or semi-persistent.

In certain embodiments, the TDCP report corresponds to a CSI report, the TDCP reporting setting corresponds to a CSI reporting setting, and a report quantity associated with the CSI reporting setting is set to a time-domain correlation indication.

In some embodiments, the CSI reporting setting comprises an ID of the at least one TRS.

In various embodiments, the set of parameters corresponding to the TDCP report comprises at least one parameter indicating a time interval over which the channel correlation is greater than a largest threshold value of a set of at least one threshold value.

In one embodiment, the time interval corresponds to a number of slots.

In certain embodiments, the time interval corresponds to a symbol index in time with respect to symbols of the at least one TRS.

In some embodiments, the time interval corresponds to a TRS index in time with respect to a sequence of periodic or semi-persistent TRS transmissions over time.

In various embodiments, the set of parameters corresponding to the TDCP report comprises a parameter indicating a time interval over which the channel correlation is within two different threshold values. In other embodiments, the set of parameters corresponding to the TDCP report comprises a parameter indicating a time interval over which the channel correlation is less than a lowest threshold value of a set of at least one threshold value.

In one embodiment, the set of parameters corresponding to the TDCP report comprises a set of time-domain correlation values corresponding to a reference TRS unit and a second TRS unit.

In certain embodiments, the reference TRS unit corresponds to: a symbol of a TRS; a TRS transmission of a sequence of periodic TRS transmissions; a TRS transmission of a sequence of semi-persistent TRS transmissions; or a combination thereof.

In some embodiments, the set of time-domain correlation values are selected from a codebook of correlation values.

In various embodiments, codewords of the codebook of correlation values are uniformly spaced with respect to: a linear domain; or a logarithmic domain.

In one embodiment, channel correlation values are computed in a differential format with respect to two consecutive TRS units.

In certain embodiments, the TDCP report is associated with a fixed payload size.

In some embodiments, a set of zero-valued bits are appended to the TDCP report so a size of the TDCP report meets the fixed payload size.

In various embodiments, the TDCP reporting setting is associated with a TRS configured with a TRS resource set configuration, and the TRS resource set configuration further comprises: an indicator of a periodicity and an offset value; an indicator of a power-control offset value; an indicator of a number of resources of the TRS; or a combination thereof.

In one embodiment, the TDCP reporting setting is associated with two TRSs.

In certain embodiments, the two TRSs are configured with: a same power-control offset value; a same periodicity value; a different offset value; or a combination thereof.

In some embodiments, the set of parameters corresponding to the TDCP report comprises: a maximum rank indicator; an indication of a rank indicator restriction; a codebook type corresponding to a PMI; a subset of a set of report quantities, the set of report quantities including a CSI-RS CRI, a RI, a PMI, a LI, a CQI, L1-RSRP, an L1-SINR; an indicator of a super slot or slot group size in terms of a number of slots; an indicator of a number of super slots or slot groups; an indicator of a format of the PMI, an indicator of a format of the CQI, an indicator field that indicates whether a QCL relationship holds over two time instants corresponding to Doppler shift, Doppler spread, average delay, delay spread, spatial relation, or a combination thereof; or a combination thereof.

In one embodiment, a method at a device, the method comprises: transmitting a TDCP reporting setting comprising configuration parameters corresponding to a TDCP report, wherein the TDCP reporting setting is associated with at least one TRS transmitted from the device; and receiving the TDCP report over a physical uplink channel, wherein the TDCP report comprises a set of parameters based on a measure of a downlink channel correlation over time.

In certain embodiments, the TRS corresponds to a NZP CSI-RS resource set configured with a TRS information configuration parameter.

In some embodiments, the TDCP report is transmitted over a PUCCH based on a time-domain behavior set to periodic or semi-persistent.

In various embodiments, a periodicity value of reporting the TDCP report is no less than a periodicity of transmitting the at least one TRS from the device.

In one embodiment, the TDCP report is transmitted over a PUSCH based on a time-domain behavior set to aperiodic or semi-persistent.

In certain embodiments, the TDCP report corresponds to a CSI report, the TDCP reporting setting corresponds to a CSI reporting setting, and a report quantity associated with the CSI reporting setting is set to a time-domain correlation indication.

In some embodiments, the CSI reporting setting comprises an ID of the at least one TRS.

In various embodiments, the set of parameters corresponding to the TDCP report comprises at least one parameter indicating a time interval over which the channel correlation is greater than a largest threshold value of a set of at least one threshold value.

In one embodiment, the time interval corresponds to a number of slots.

In certain embodiments, the time interval corresponds to a symbol index in time with respect to symbols of the at least one TRS.

In some embodiments, the time interval corresponds to a TRS index in time with respect to a sequence of periodic or semi-persistent TRS transmissions over time.

In various embodiments, the set of parameters corresponding to the TDCP report comprises a parameter indicating a time interval over which the channel correlation is within two different threshold values. In other embodiments, the set of parameters corresponding to the TDCP report comprises a parameter indicating a time interval over which the channel correlation is less than a lowest threshold value of a set of at least one threshold value.

In one embodiment, the set of parameters corresponding to the TDCP report comprises a set of time-domain correlation values corresponding to a reference TRS unit and a second TRS unit.

In certain embodiments, the reference TRS unit corresponds to: a symbol of a TRS; a TRS transmission of a sequence of periodic TRS transmissions; a TRS transmission of a sequence of semi-persistent TRS transmissions; or a combination thereof.

In some embodiments, the set of time-domain correlation values are selected from a codebook of correlation values.

In various embodiments, codewords of the codebook of correlation values are uniformly spaced with respect to: a linear domain; or a logarithmic domain.

In one embodiment, channel correlation values are computed in a differential format with respect to two consecutive TRS units.

In certain embodiments, the TDCP report is associated with a fixed payload size.

In some embodiments, a set of zero-valued bits are appended to the TDCP report so a size of the TDCP report meets the fixed payload size.

In various embodiments, the TDCP reporting setting is associated with a TRS configured with a TRS resource set configuration, and the TRS resource set configuration further comprises: an indicator of a periodicity and an offset value; an indicator of a power-control offset value; an indicator of a number of resources of the TRS; or a combination thereof.

In one embodiment, the TDCP reporting setting is associated with two TRSs.

In certain embodiments, the two TRSs are configured with: a same power-control offset value; a same periodicity value; a different offset value; or a combination thereof.

In some embodiments, the set of parameters corresponding to the TDCP report comprises: a maximum rank indicator; an indication of a rank indicator restriction; a codebook type corresponding to a PMI; a subset of a set of report quantities, the set of report quantities including a CSI-RS CRI, a RI, a PMI, a LI, a CQI, a L1-RSRP, an L1-SINR; an indicator of a super slot or slot group size in terms of a number of slots; an indicator of a number of super slots or slot groups; an indicator of a format of the PMI, an indicator of a format of the CQI, an indicator field that indicates whether a QCL relationship holds over two time instants corresponding to Doppler shift, Doppler spread, average delay, delay spread, spatial relation, or a combination thereof; or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a time-domain channel property (TDCP) reporting setting comprising configuration parameters corresponding to a TDCP report, wherein the TDCP reporting setting is associated with at least one tracking reference signal (TRS) received at the UE; and
transmit the TDCP report over a physical uplink channel, wherein the TDCP report comprises a set of parameters based on a measure of a downlink channel correlation over time.

2. The UE of claim 1, wherein the TRS corresponds to a non-zero power (NZP) channel state information (CSI) reference signal (RS) (CSI-RS) resource set configured with a TRS information configuration parameter.

3. The UE of claim 1, wherein the TDCP report is transmitted over a physical uplink control channel (PUCCH) based on a time-domain behavior set to periodic or semi-persistent, and a periodicity value of reporting the TDCP report is no less than a periodicity of receiving the at least one TRS at the UE.

4. The UE of claim 1, wherein the TDCP report is transmitted over a physical uplink shared channel (PUSCH) based on a time-domain behavior set to aperiodic or semi-persistent.

5. The UE of claim 1, wherein the TDCP report corresponds to a CSI report, the TDCP reporting setting corresponds to a CSI reporting setting, and a report quantity associated with the CSI reporting setting is set to a time-domain correlation indication.

6. The UE of claim 5, wherein the CSI reporting setting comprises an identification (ID) of the at least one TRS.

7. The UE of claim 1, wherein the set of parameters corresponding to the TDCP report comprises at least one parameter indicating a time interval over which the downlink channel correlation is greater than a largest threshold value of a set of at least one threshold value.

8. The UE of claim 7, wherein the time interval corresponds to a number of slots, a symbol index in time with respect to symbols of the at least one TRS, or a TRS index in time with respect to a sequence of periodic or semi-persistent TRS transmissions over time.

9. The UE of claim 1, wherein the set of parameters corresponding to the TDCP report comprises a parameter indicating a time interval over which the downlink channel correlation is within two different threshold values.

10. The UE of claim 1, wherein the set of parameters corresponding to the TDCP report comprises a parameter indicating a time interval over which the downlink channel correlation is less than a lowest threshold value of a set of at least one threshold value.

11. The UE of claim 1, wherein the set of parameters corresponding to the TDCP report comprises a set of time-domain correlation values corresponding to a reference TRS unit and a second TRS unit.

12. The UE of claim 11, wherein the reference TRS unit corresponds to:
a symbol of a TRS;
a TRS transmission of a sequence of periodic TRS transmissions;
a TRS transmission of a sequence of semi-persistent TRS transmissions;
or a combination thereof.

13. The UE of claim 11, wherein the set of time-domain correlation values are selected from a codebook of correlation values, and codewords of the codebook of correlation values are uniformly spaced with respect to a logarithmic domain.

14. The UE of claim 11, wherein channel correlation values are computed in a differential format with respect to two consecutive TRS units.

15. The UE of claim 1, wherein the TDCP report is associated with a fixed payload size.

16. The UE of claim 15, wherein a set of zero-valued bits are appended to the TDCP report so a size of the TDCP report meets the fixed payload size.

17. The UE of claim 1, wherein the TDCP reporting setting is associated with two TRSs, the two TRSs are configured with:
a same power-control offset value;
a same periodicity value;
a different offset value;
or a combination thereof.

18. A processor for wireless communication, comprising:
at least one controller coupled with at least one memory and configured to cause the processor to:
receive a time-domain channel property (TDCP) reporting setting comprising configuration parameters corresponding to a TDCP report, wherein the TDCP reporting setting is associated with at least one tracking reference signal (TRS) received at the processor; and
transmit the TDCP report over a physical uplink channel, wherein the TDCP report comprises a set of parameters based on a measure of a downlink channel correlation over time.

19. A method performed by a user equipment (UE), the method comprising:
receiving a time-domain channel property (TDCP) reporting setting comprising configuration parameters corresponding to a TDCP report, wherein the TDCP reporting setting is associated with at least one tracking reference signal (TRS) received at the UE; and
transmitting the TDCP report over a physical uplink channel, wherein the TDCP report comprises a set of parameters based on a measure of a downlink channel correlation over time.

20. A base station, comprising:
at least one memory; and
at least one processor coupled with the at least one memory and configured to cause the base station to:
transmit a time-domain channel property (TDCP) reporting setting comprising configuration parameters corresponding to a TDCP report, wherein the TDCP reporting setting is associated with at least one tracking reference signal (TRS) transmitted from the base station; and
receive the TDCP report over a physical uplink channel, wherein the TDCP report comprises a set of parameters based on a measure of a downlink channel correlation over time.
